(19) United States
(12) Patent Application Publication
(10) Pub. No.: US 2008/0010557 A1
(43) Pub. Date: Jan. 10, 2008

(54) Storage apparatus and control apparatus

(75) Inventor: Toshimitsu Kume, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/526,843

(22) Filed: Sep. 25, 2006

(30) Foreign Application Priority Data
May 19, 2006 (JP) 2006-140181

(51) Int. Cl. G06F 11/00

(52) U.S. Cl. 714/47

(57) ABSTRACT

A magnetic disk apparatus comprises a failure prediction condition detection unit and a failure prediction time operation logic unit. The failure prediction condition detection unit notifies the failure prediction time operation logic unit when detecting an establishment of a failure prediction condition. Having received the notification, the failure prediction time operation logic unit instructs to execute a failure prediction-time operation which is predetermined corresponding to a failure prediction condition. The failure prediction-time operation includes an operation for trying to return to a normal state and/or protecting data.

### BACKGROUND OF THE INVENTION

1. Field of the Invention

The present invention relates to a storage apparatus, a control method therefor and a control apparatus; and specifically to a method and the control apparatus for controlling the storage apparatus in a state in which a failure occurrence is predicted and to the storage apparatus controlled by the aforementioned method or control apparatus.

2. Description of the Related Art

In recent years, many a hard disk drive (simply “HDD” hereinafter) is equipped with a Self-Monitoring Analysis and Reporting Technology (SMART) function. The SMART function is one for an HDD predicting a failure occurrence and warning a host (i.e., a computer utilizing the aforementioned HDD).

An HDD equipped with the SMART function monitors various inspection items such as error occurrence frequency, predicts an occurrence of a failure based on a comparison result between a value of each inspection item and a predefined threshold value and warns the host.

Having received the warning from the HDD, the host backs up data stored in the HDD, changes over from the HDD to another HDD, or warns a user to replace the HDD. Such an adequate action makes it possible to suppress a loss (i.e., a loss of data, et cetera) due to an HDD failure.

The conventional SMART function, however, lets the HDD itself process commands in the same manner as a normal state following a mere issuance of a warning. There has consequently been a problem of the HDD per se being unable to participate in whether or not an adequate action is provided at a suitable timing against the warning.

For instance, if a host cannot respond to the warning from the HDD, it continues an operation of the aforementioned HDD, possibly resulting in deteriorating the HDD so as to cause a failure occurrence and the HDD becoming inoperable. Or, there is a case of the host or personnel unable to respond to the warning from the HDD within an adequate time period. In such a case, if the operation of the aforementioned HDD is continued in a period until a certain action, such as a replacement of the HDD, is taken, the state of the HDD may result in deteriorating to cause a failure occurrence in the period, possibly leading to a loss of a part of the data.

There are known conventional techniques as follows, none of which provides a solution to the above described problem:

An HDD according to a patent document 1 is equipped with the mechanism for preventing damage due to a shock of a fall. Conventionally, if a person carelessly drops a laptop computer for example, the built-in HDD suffered damage due to a shock of the drop. The HDD according to the patent document 1 predicts a shock occurrence from information such as acceleration sensor and makes the magnetic head of the HDD take shelter at a predetermined position, thereby preventing damage. The patent document 1, however, specializing in a countermeasure to damage due to a shock, does not refer to a case of an occurrence of a failure in association with a secular degradation for instance. Different countermeasures are necessary between a shock of a drop ending in less than a second and a secular degradation in which a degradation of a state progresses gradually.

Meanwhile, an apparatus according to a patent document 2, being one including an HDD, monitors a state thereof and backs up a predetermined file among files recorded in the HDD to another small capacity HDD if the apparatus predicts an impending failure occurrence in the HDD. It, however, does not let the HDD per se participate in the control of the backup and therefore the patent document 2 is not concerned with solving the above described problem.

A patent document 3 in the meantime relates to a digital image forming apparatus equipped with an HDD. The apparatus makes information stored in an area, where an impending failure is predicted, within the HDD take shelter by printing and outputting, or transferring the information to another storage apparatus or another area of the HDD. The apparatus also sometimes inhibits a specific mode utilizing the area where the impending failure is predicted. The HDD per se, however, does not participate in such controls, nor does the patent document 3 note on a case of the entirety of the HDD, instead of just the specific area, being affected (e.g., in the case of predicting a failure occurrence due to an operation in high temperatures, or other similar cases), and therefore it is not useful for solving the above described problem.

[Patent document 1] Laid-Open Japanese Patent Application Publication No. 2004-146036

[Patent document 2] Laid-Open Japanese Patent Application Publication No. 09-6545

[Patent document 3] Japanese Registered Patent No. 3585691

### SUMMARY OF THE INVENTION

A purpose of the present invention is to provide a storage apparatus predicting an occurrence of a failure and also autonomously carrying out a process of trying to return to a normal state and/or a process for protecting data in a state of predicting an occurrence of a failure. Another purpose is to provide a control apparatus controlling such a storage apparatus in the aforementioned manner.

According to the present invention, a storage apparatus receiving either category of a command among a plurality of categories including a reading of data from a storage medium or a writing of data thereto and carrying out the command comprises a failure prediction condition detection unit and a failure prediction time operation logic unit. The failure prediction condition detection unit detects whether or not a predefined failure prediction condition, as a condition for a failure occurrence being predicted, is established. The failure prediction time operation logic unit instructs an execution of an operation which is predetermined corresponding to the failure prediction condition when the failure prediction condition detection unit detects an establishment of the failure prediction condition.

And according to the present invention, a control apparatus, being an apparatus controlling the storage apparatus, comprises a failure prediction condition detection unit and a failure prediction time operation logic unit which are the same as described above.

While the failure prediction conditions and the operations predetermined in correspondence therewith are diversely different depending on embodiments, the operations include one for trying to return to a normal state from a state of a failure occurrence being predicted and one for protecting data. A specific configuration necessary for the failure prediction condition detection unit for a certain embodiment varies with the failure prediction condition in the embodiment.

The respective functions of the failure prediction condition detection unit and failure prediction time operation logic unit can be implemented by programs.

The storage apparatus according to the present invention is contrived to autonomically carry out a process for trying to return to a normal state and/or a process for protecting data without relying on an external instruction when predicting an occurrence of a failure. Therefore, the storage apparatus according to the present invention is capable of suppressing a failure occurrence or extending a period of time before a failure occurrence in the case of continuing the operation of the storage apparatus because a host or a user is unable to take measure against a warning from the storage apparatus predicting a failure occurrence or the case of needing time until the host or the user takes a certain measure.

That is, the storage apparatus according to the present invention is capable of processing data more securely as compared to the conventional method in an operation in a state of a failure occurrence being predicted. In the case of controlling a storage apparatus by using the control apparatus according to the present invention, the same benefit is obtained. Therefore, the present invention contributes much to an improvement of the reliability of a storage apparatus.

### BRIEF DESCRIPTION OF THE DRAWINGS

FIG. 1 is a diagram describing the principle of the present invention;

FIGS. 2A and 2B are diagrams exemplifying a failure prediction condition with the related hardware of a failure prediction condition detection unit and the related failure prediction-time operation;

FIG. 3 is a block diagram of a functional configuration according to an embodiment of the present invention;

FIG. 4 is a flow chart showing an operation of a magnetic disk apparatus according to an embodiment; and

FIG. 5 is a flow chart of a command process carried out by a magnetic disk apparatus according to an embodiment.

### DESCRIPTION OF THE PREFERRED EMBODIMENTS

The following is a detailed description of the preferred embodiment of the present invention by referring to the accompanying drawings.

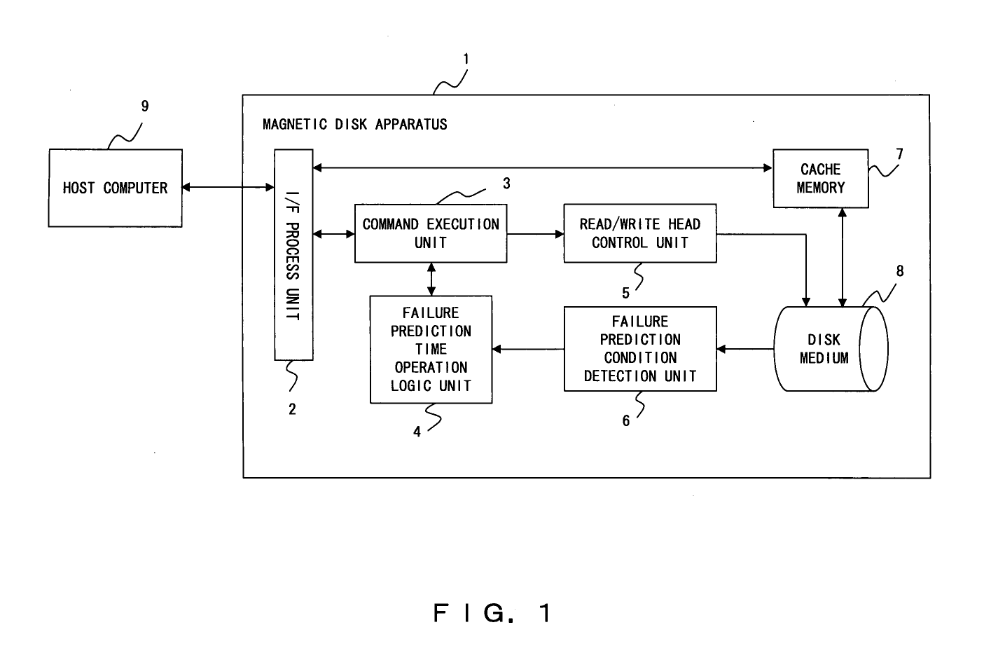

FIG. 1 is a diagram describing the principle of the present invention. A magnetic disk apparatus 1, being a kind of storage apparatus, is one receiving a command such as a data readout or writing from a host computer 9 and carrying out the command. A concrete example of the magnetic disk apparatus 1 is an HDD. The magnetic disk apparatus 1 according to the present invention has a part similar to the conventional magnetic disk apparatus and a part unique to the present invention.

The magnetic disk apparatus 1, as the same as the conventional one, comprises an interface process unit 2 (simply called “I/F process unit” hereinafter), a command execution unit 3, a read/write head control unit 5, cache memory 7 and a magnetic disk medium 8. And being the same as the conventional magnetic disk apparatus equipped with a SMART function, the magnetic disk apparatus 1 further comprises a failure prediction condition detection unit 6. The magnetic disk apparatus 1 further comprises a failure prediction time operation logic unit 4 which is unique to the present invention. Note that FIG. 1 indicates primary directions of processes by arrows connecting respective components. Strictly noting, a place where a unidirectional arrow is shown sometimes accompanies an auxiliary process which would be indicated by an arrow in the opposite direction.

The magnetic disk apparatus 1 comprises a disk medium 8 as a storage medium in which data are stored. In the case where the magnetic disk apparatus 1 is an HDD, the disk medium 8 is constituted by one or more pieces of disks coated with a magnetic body and a spindle motor (not shown herein) rotates the disk medium 8. A magnetic head (simply called “head” hereinafter), being mounted onto an arm driven by a voice coil motor, carries out a reading, and a writing, of data on the disk medium 8. The voice coil motor, arm and head are all used for the conventional magnetic disk apparatus and therefore are intentionally omitted showings herein. Note that a reading, or writing, of data on the disk medium 8 is carried out according to a command transmitted from the host computer 9 to the magnetic disk apparatus 1.

The host computer 9 is a computer utilizing the magnetic disk apparatus 1. The name “host” is for showing that it is positioned in an upper layer with regard to the magnetic disk apparatus 1 and not intended for specifying a category of a computer. The host computer 9 may be a discretionary category of computer such as a personal computer (PC) and a work station. Meanwhile, the magnetic disk apparatus 1 may be externally attached to the host computer 9 or the both may be housed in the same chassis.

The I/F process unit 2 is an interface carrying out a communication with the host computer 9. A command, data as a target of processing the command, status information on the magnetic disk apparatus 1, et cetera, are exchanged between the magnetic disk apparatus 1 and host computer 9 by way of the I/F process unit 2.

A command transmitted from the host computer 9 to the magnetic disk apparatus 1 is received at the I/F process unit 2 and then transmitted to the command execution unit 3 which then analyzes and processes the received command. That is, the command execution unit 3 analyzes the command and calculates as to what position of the disk medium 8 the head is to be moved to in order to carry out the relevant command.

For instance, if the magnetic disk apparatus 1 is an HDD and its disk medium 8 is constituted by a plurality of disks, there is a plurality of heads corresponding thereto. In this case, the command execution unit 3 calculates a physical position (which is indicated by a cylinder number, a head number and a track number), on the disk medium 8, of a process target block of a command to be carried out, and notifies the read/write head control unit 5 of the calculation result.

The command execution unit 3 also requests the host computer 9 by way of the I/F process unit 2 for transmitting data if the command is one associated with a data writing to the disk medium 8.

Based on the calculation result of the command execution unit 3, the read/write head control unit 5 carries out a positioning control for the head (i.e., a seek control) and a read/write control. This makes a reading of data stored in the disk medium 8 or a writing of data thereto. That is, the command execution unit 3 and read/write head control unit 5 collaborate to carry out a command.

The cache memory 7 is memory for storing the read data or the write data temporarily and is constituted by semiconductor memory. The cache memory 7 enables the concealment, from the host computer 9, of a slow access to the disk medium 8.

In the case of the host computer 9 issuing a kind of command for a write (simply called “write series command” hereinafter) for instance, the data transmitted from the host computer 9 based on a request from the command execution unit 3 as described above is once written to the cache memory 7. And the data is written to the disk medium 8 by the command execution unit 3 and read/write head control unit 5.

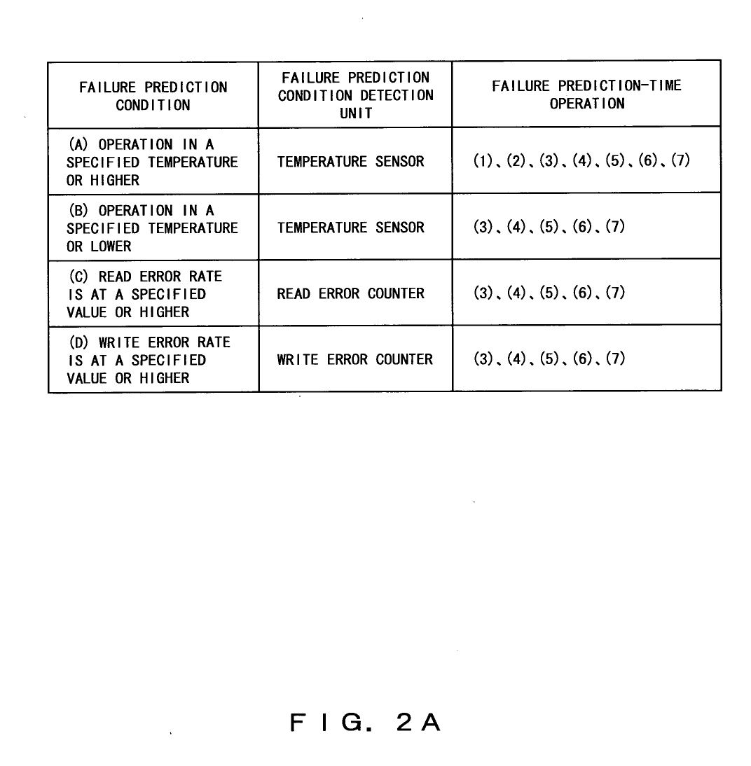

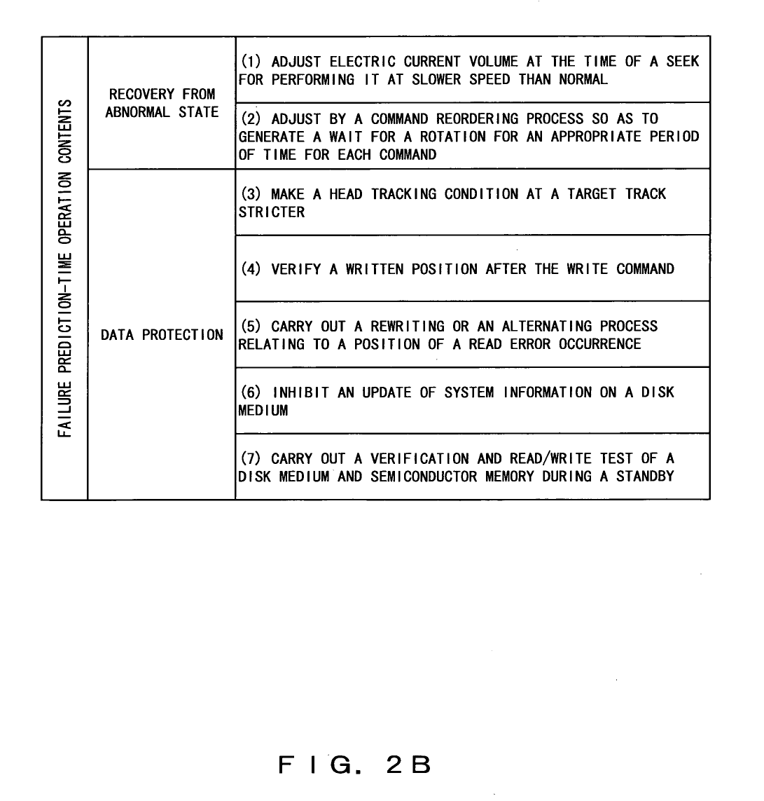

Such is a command process at a normal time. Incidentally, one or more conditions (simply called “failure prediction condition” hereinafter) of predicting a failure of the magnetic disk apparatus 1 are predefined based on temperature, various error rates, et cetera, while the details are described later in association with FIGS. 2A and 2B, where the error rate is defined as a generic term for a read error rate, a write error rate, a seek error rate, et cetera.

The failure prediction condition detection unit 6 monitors the temperature, error rate, et cetera, thereby detecting whether or not either of the failure prediction conditions is established. This configuration is the same as a conventional magnetic disk apparatus equipped with the SMART function.

A difference between the conventional method and present invention lies where the failure prediction condition detection unit 6 notifies the failure prediction time operation logic unit 4 in the case of at least one of the failure prediction condition being established (simply called “failure prediction state” hereinafter). Another difference from the conventional method also lies where an operation to be carried out (simply called “failure prediction-time operation” hereinafter) at the time of establishing the failure prediction condition are predetermined in correspondence with each failure prediction condition.

The examples of the failure prediction-time operations include an operation for returning to a normal state (that is, a state of not establishing a failure prediction condition) from the failure prediction state and an operation for protecting data. The failure prediction-time operation corresponding to one failure prediction condition may be one or a combination of a plurality of operations. Or, a single failure prediction-time operation may correspond to different failure prediction conditions.

While the above description omits, the command execution unit 3 in the embodiment shown by FIG. 1 inquires the failure prediction time operation logic unit 4 as to whether or not it is in a failure prediction state when analyzing a command. If it is not in a failure prediction state, the command execution unit 3 processes a command as described above. If it is in a failure prediction state, the failure prediction time operation logic unit 4 instructs the command execution unit 3 to carry out a failure prediction-time operation corresponding to the failure prediction condition in which an establishment of the condition is detected. The command execution unit 3 processes the command while carrying out the failure prediction-time operation. The command execution unit 3 also transmits a warning to the host computer 9 by way of the I/F process unit 2. As such, different processes are carried out between the time of a normal state (i.e., not in a failure prediction state) and that of the failure prediction state.

Depending on embodiment, the command execution unit 3 may carry out a process for protecting data according to an instruction from the failure prediction time operation logic unit 4 if there is no command to be executed (that is, in an idle state).

As described above, the magnetic disk apparatus 1 according to the present invention is contrived to not only transmit a warning to the host computer 9 but also autonomously take an appropriate action against the failure prediction state (that is, to carry out a failure prediction-time operation) based on an instruction from the failure prediction time operation logic unit 4. This contrivance enables the magnetic disk apparatus 1 to return to a normal state, an extension of time between actual failure occurrences and a lower possibility of damage occurrence such as a data loss.

Note that FIG. 1 shows functional blocks. Within FIG. 1, the cache memory 7 and disk medium 8 show different pieces of hardware, the rest of components, i.e., the I/F process unit 2, command execution unit 3, failure prediction time operation logic unit 4, read/write head control unit 5 and failure prediction condition detection unit 6, however, may be implemented by a hardware circuit for each block, or by a piece of firmware for each block according to an embodiment. In the case of implementing each block by firmware, the hardware may be common across these functional blocks. It is of course possible to implement a part of blocks by a hardware circuit(s) and a part of blocks by firmware. It is also possible to implement a part of a function of one block by hardware and a part by firmware.

For instance, four functional blocks, i.e., the I/F process unit 2, command execution unit 3, failure prediction time operation logic unit 4 and read/write head control unit 5, are implemented by firmware and by a common piece of hardware in a certain embodiment. Meanwhile, the failure prediction condition detection unit 6 includes unique pieces of hardware such as sensor and other parts implemented by firmware. The hardware corresponding to the firmware is common with the above described four functional blocks.

For example, the common hardware implementing these functional blocks may be a computer which includes a processor, nonvolatile memory such as flash memory and Read Only Memory (ROM), and volatile memory such as Random Access Memory (RAM). And, the nonvolatile memory stores a firmware program for implementing a function of the above described each functional block so that the firmware program is loaded onto the processor and executed thereby, thereby implementing the functions of the above described functional blocks, respectively.

It is also possible to store the firmware program in a computer readable portable storage medium. The example of the portable storage medium includes an optical disk such as compact disk (CD) and digital versatile disk (DVD), a magneto optical disk, and a flexible disk. Alternatively, a program provider may provide the firmware program by way of a network. In the case of the above noted nonvolatile memory being rewritable, the firmware program stored in the portable storage medium or provided by the program provider is read by the magnetic disk apparatus 1 by way of the I/F process unit 2, thereby enabling an update of the firmware program. This further makes it possible to update a correspondence between a failure prediction condition and a failure prediction-time operation for example.

FIGS. 2A and 2B are diagrams exemplifying a failure prediction condition with the related hardware of the failure prediction condition detection unit 6 and the related failure prediction-time operation. The “failure prediction condition” column in the table shown by FIG. 2A exemplifies failure prediction conditions. The “failure prediction condition detection unit” column shows a part of detecting a failure prediction condition of the applicable row among kinds of hardware comprised by the failure prediction condition detection unit 6 shown in FIG. 1. The “failure prediction-time operation” column shows contents of operations which the failure prediction time operation logic unit 4 instructs the command execution unit 3 when a failure prediction condition described in the applicable row is detected.

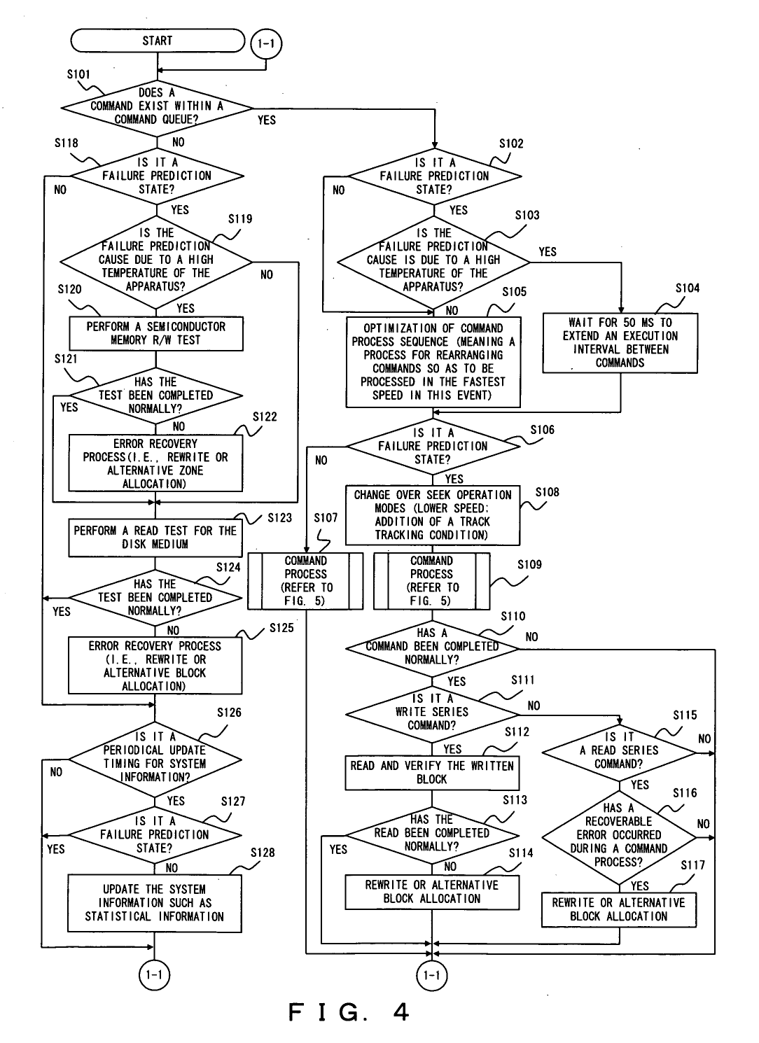

For example, if a temperature sensor detects temperature of a specified temperature or higher in an embodiment in which the failure prediction condition detection unit 6 includes the temperature sensor, the failure prediction condition (A) in the table is established. The failure prediction condition detection unit 6 accordingly notifies the failure prediction time operation logic unit 4 of the fact. Then, responding to an inquiry from the command execution unit 3, the failure prediction time operation logic unit 4 instructs the command execution unit 3 to carry out the failure prediction-time operations (1) through (7) shown by the table of FIG. 2B. Details of the failure prediction-time operations (1) through (7) are described later in association with FIG. 4.

Note that the “specified temperature” shown in the failure prediction conditions (A) and (B) are temperature values predefined as a specification for the magnetic disk apparatus 1, which are the upper and lower limit of temperature, respectively, under which a normal operation of the magnetic disk apparatus 1 is guaranteed.

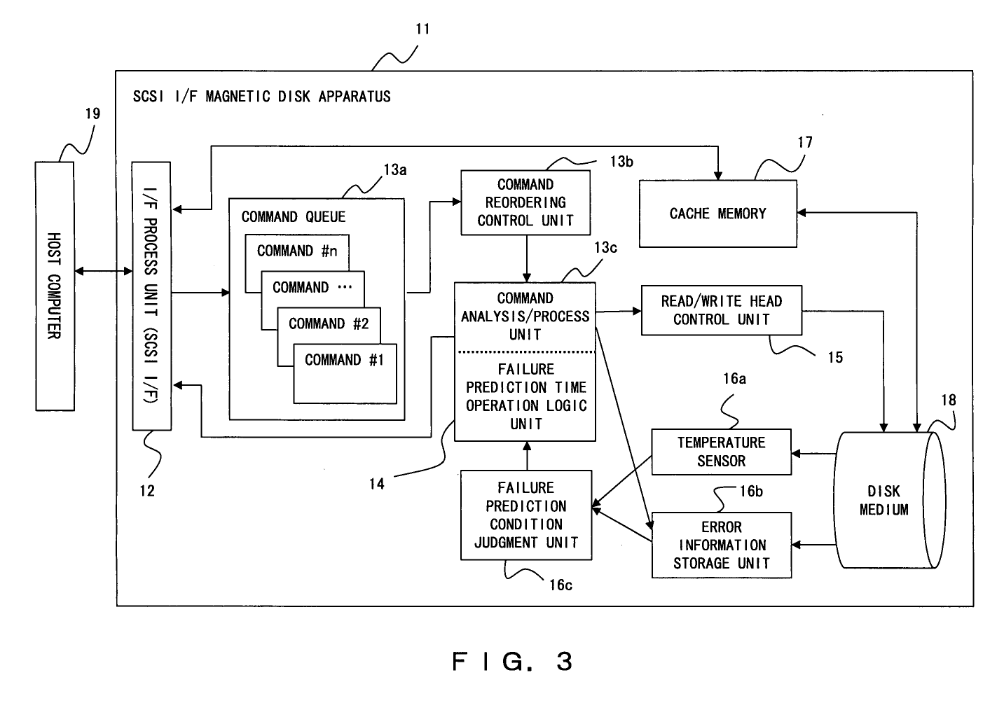

FIG. 3 is a block diagram of a functional configuration according to an embodiment of the present invention. A magnetic disk apparatus 11 according to the present embodiment is a magnetic disk apparatus equipped with a Small Computer System Interface (SCSI) interface and is configured approximately the same as the magnetic disk apparatus 1 shown by FIG. 1. FIG. 3 also shows primary flow of operations by directions of arrows as in the case of FIG. 1.

The I/F process unit 12 corresponds to the I/F process unit 2 shown in FIG. 1. The interface form of the I/F process unit 12 is a SCSI interface.

A command queue 13a, a command reordering control unit 13b and a command analysis/process unit 13c are included in the command execution unit 3 shown in FIG. 1.

The command queue 13a is a queue for storing commands received from a host computer 19 by way of the I/F process unit 12. FIG. 3 shows a configuration enabling the command queue 13a to store n pieces of commands, i.e., from a “command #1” to a “command #n”. Hardware implementing the command queue 13a is RAM for example.

The command reordering control unit 13b determines an execution sequence of commands within the command queue 13a. In a normal state, the command reordering control unit 13b determines an execution sequence of commands so as to process them most effectively (that is, in the highest speed). The present embodiment is configured to implement the command reordering control unit 13b by firmware.

The command analysis/process unit 13c carries out commands in a sequence determined by the command reordering control unit 13b. In order to carry out a command, the command analysis/process unit 13c calculates a physical position of a process target block of the aforementioned command on the disk medium 18 and notifies a read/write head control unit 15 of it. The present embodiment is configured to implement also the command analysis/process unit 13c by firmware.

A failure prediction time operation logic unit 14 and a read/write head control unit 15 correspond to the failure prediction time operation logic unit 4 and read/write head control unit 5, respectively, which are shown in FIG. 1. Their descriptions are omitted because they are the same as ones shown in FIG. 1.

A temperature sensor 16a, an error information storage unit 16b and a failure prediction condition judgment unit 16c are included in the failure prediction condition detection unit 6 shown in FIG. 1.

The temperature sensor 16a is hardware for monitoring temperature and outputting temperature information. The temperature sensor 16a is preferably to be installed internally to the chassis of the magnetic disk apparatus 11. A person skilled in the art is capable of determining an installation position of the temperature sensor 16a appropriately.

The error information storage unit 16b records error information. Hardware implementing the error information storage unit 16b may be a register or volatile memory such as RAM for example. In the case of an embodiment utilizing the failure prediction conditions (C) and (D) shown in FIG. 2A for example, the error information storage unit 16b may include a read error counter and a write error counter, or a storage unit (e.g., a register, RAM, et cetera) for recording a read error rate and a write error rate.

The error information is recorded by the error information storage unit 16b in the following manner. First, as an error occurs in a read process or write process, the read/write head control unit 15 detects the error occurrence and reports it to the command analysis/process unit 13c which detects the error occurrence thereby and records the error information in the error information storage unit 16b.

The failure prediction condition judgment unit 16c judges whether or not a failure prediction condition is established based on the information obtained from the temperature sensor 16a and error information storage unit 16b. The present embodiment is configured to implement the failure prediction condition judgment unit 16c by firmware.

The failure prediction condition judgment unit 16c may be configured to read information periodically from the temperature sensor 16a and error information storage unit 16b. An alternative configuration may be such that the temperature sensor 16a outputs information to the failure prediction condition judgment unit 16c autonomously. Or it may be such that the command analysis/process unit 13c notifies the failure prediction condition judgment unit 16c when the command analysis/process unit 13c rewrites the error information storage unit 16b prompted by an error occurrence.

For example, the failure prediction condition judgment unit 16c may obtain a temperature from the temperature sensor 16a at every certain period of time and may judge a failure prediction condition being established by a cause of an operation in high temperature (which corresponds to the failure prediction condition (A) shown in FIG. 2A) if a state of the obtained temperature being the specified temperature or higher has continued for a specified time period or longer.

A cache memory 17, a disk medium 18 and a host computer 19 correspond to, and are the same as, the cache memory 7, disk medium 8 and host computer 9, respectively, which are shown in FIG. 1.

Note that firmware or a hardware circuit is also necessary for controlling the cache memory 17 although it is not shown in a drawing herein. For example, the firmware program may be configured by being built in as a part of a firmware program of the command analysis/process unit 13c, or as an independent program.

FIG. 4 is a flow chart showing an operation of the magnetic disk apparatus 11 according to an embodiment. The process shown by FIG. 4 is repeatedly carried out while the magnetic disk apparatus 11 is in operation. Note that the step relating to the function of warning the host computer 19 when detecting a failure prediction condition being established is the same as the conventional method, and therefore its description is omitted in the flow chart of FIG. 4.

In the step S101, the command reordering control unit 13b judges whether or not a command exists in the command queue 13a. If a command exists in the command queue 13a, the judgment is “yes” and the flow shifts to the step S102 for processing the command. If a command does not exist in the command queue 13a, the judgment is “no” in which case the magnetic disk apparatus 11 is in a standby state (i.e., an idle state) and therefore the flow shifts to the step S118 for maintaining the magnetic disk apparatus 11.

The steps from the S102 through to the S117 are ones carried out in which a command, and a failure prediction-time operation at a failure prediction state, are carried out when a command exists in the command queue 13a.

In the step S102, the command analysis/process unit 13c inquires the failure prediction time operation logic unit 14 whether or not it is a failure prediction state. If it is a failure prediction state, the judgment of the step S102 is “yes”, and the flow shifts to the step S103. If it is not a failure prediction state, the judgment is “no” and the flow shifts to the step S105.

The step S103 judges whether or not the establishment of the failure prediction condition is due to a high temperature. Here, an example configuration may be such that a judgment is based on a result of the inquiry in the step S102, or is based on the command analysis/process unit 13c inquiring the failure prediction time operation logic unit 14 once again. If the judgment is that the failure prediction condition is due to a high temperature, the judgment is “yes”, prompting the flow shifting to the step S104, otherwise the judgment is “no”, prompting the flow shifting to the step S105. In the example shown in FIG. 2A, the judgment of the step S103 is “yes” only in the case of establishing the failure prediction condition (A).

The step S104 is a concrete example of the failure prediction-time operation (2) corresponding to the failure prediction condition (A), which is carried out according to an instruction given to the command analysis/process unit 13c by the failure prediction time operation logic unit 14.

The step S104 waits for 50 milliseconds (“ms” hereinafter) until the command analysis/process unit 13c issues an instruction to the read/write head control unit 15. That is, the command analysis/process unit 13c inserts 50 ms of a rotation wait time, thereby extending a command execution interval. Because the main cause of heating the magnetic disk apparatus 11 (i.e., the disk medium 18 especially) is a command execution (i.e., the seek operation especially), the process in the step S104 has an effect in suppressing a temperature rise of the magnetic disk apparatus 11.

While the process of FIG. 4 is repeatedly carried out as noted before, the temperature of the magnetic disk apparatus 11 sometimes decreases to a temperature below the specified temperature of the failure prediction condition (A) shown in FIG. 2A for example, if the step S104 is carried out at every repetition. That is, it is also possible for the magnetic disk apparatus 11 returning to a normal state from a failure prediction state as a result of carrying out the failure prediction-time operation of the step S104. Having waited for 50 ms, the flow shifts to the step S106.

In the step S105, the command reordering control unit 13b determines an execution sequence of commands within the command queue 13a. The step S105 is carried out in a normal state or a state of a failure prediction condition being established due to a cause other than a high temperature. Therefore, a temperature rise of the magnetic disk apparatus 11 is not necessary to be suppressed in the step S105, the command reordering control unit 13b accordingly reorders (i.e., to rearrange) an execution sequence of commands within the command queue 13a so optimized as to be processed at the highest speed (i.e., minimizing wait time). Having reordered, the flow shifts to the step S106.

Incidentally, if a failure prediction state is judged due to a high temperature, then the step S105 is not carried out. In other words, a failure prediction-time operation of inhibiting an execution of the step S105 is carried out in this case. Therefore, it is a state of not optimizing commands within the command queue 13a. In this case, a wait time between commands is long, making a movement of the head less frequent and suppressing a temperature rise of the magnetic disk apparatus 11 as compared to the case of carrying out the process of the step S105.

The step S106, as in the step S102, judges whether or not it is a failure prediction state. If it is a failure prediction state, the judgment is “yes”, prompting the process shifting to the step S108. The steps S108 through S117 are concrete example of operations that the failure prediction time operation logic unit 14 instructs the command analysis/process unit 13c so as to carry out as failure prediction-time operations. If it is not a failure prediction state the judgment is “no” and the flow shifts to the step S107.

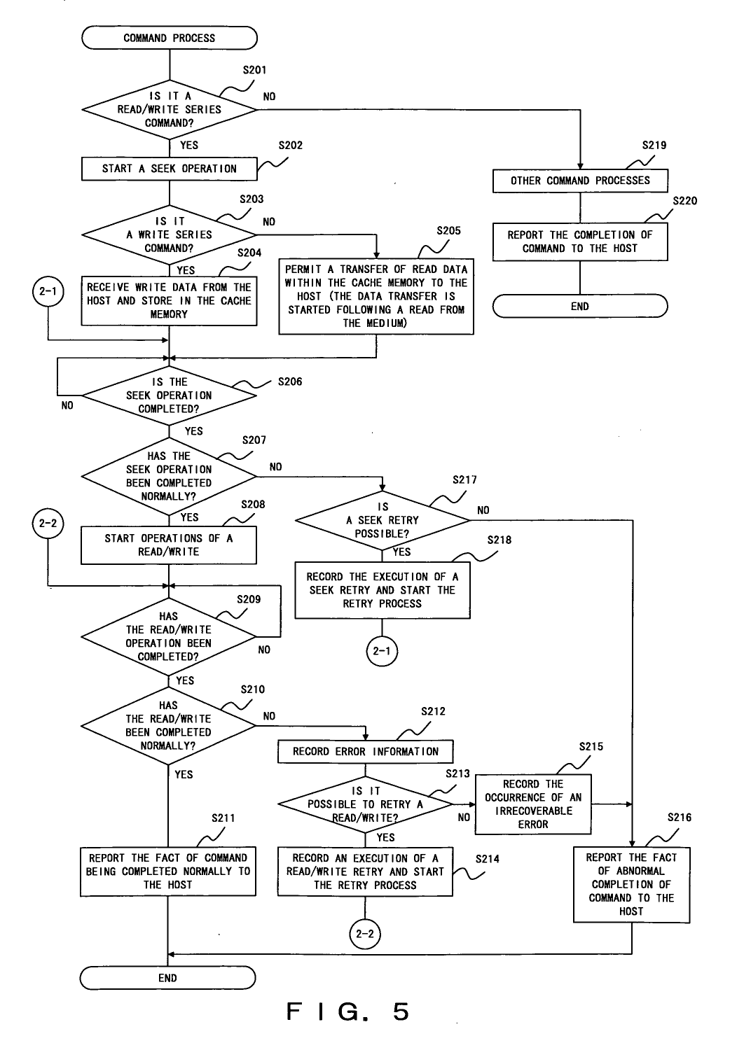

The step S107 processes a command to be processed first among the commands within the command queue 13a. The command analysis/process unit 13c gives the read/write head control unit 15 an instruction for carrying out the aforementioned command, while the details are described later in association with FIG. 5. The command process of the step S107 includes a retry process in the case of failing a normal process. Having processed the command, the process returns to the step S101.

In the step S108, the command analysis/process unit 13c instructs the read/write head control unit 15 for changing over operation modes of a seek operation. The present embodiment is configured to perform the following two kinds of changeover of operation modes:

First, if a failure prediction condition due to a high temperature is established, the read/write head control unit 15 reduces an electric current volume flowing to the voice coil motor at the time of a seek operation. This makes the seek operation slower than in a normal state, thereby reducing the power consumption volume and hence the heat generation amount.

Second, the read/write head control unit 15 makes a head tracking condition stricter independent of the kind of an established failure prediction condition. That is, the read/write head control unit 15 makes a positioning condition for moving the head to a target track position stricter. For example, if a positioning condition is defined by a logical product (i.e., AND) of a plurality of conditions, it increases the number of conditions of components for a positioning condition. This configuration enables the head to position itself at the center of a track more securely because the head is not regarded to be stabilized at a target position until a stricter condition is established as compared to a condition at the normal state.

For instance, let it be assumed a specification for performing a seek operation while reading position information recorded on a track, and at the normal state, regarding the head moving to a target position and being stabilized thereat when the readout position information indicates the target track position for a consecutive two readouts. In this case, changing the specification in a manner to regard the head moving to a target position and being stabilized thereat when the readout position information indicates the target track position for a consecutive four readouts corresponds to making the head tracking condition stricter, for example. This results in extending a seek time as compared to that in a normal state. However, an occurrence of an error (e.g., resulting from writing data at a position displaced from the center of a track, an error generated at the time of carrying out a read series command thereafter) due to an inadequate head position is suppressed.

Having the mode changeover being carried out as described above, the process shifts to the step S109.

The step S109, as in the step S107, processes a command to be processed first among commands within the command queue 13a. Having processed the command, the flow shifts to the step S110.

In the step S110, the command analysis/process unit 13c judges whether or not the command is completed normally. If the command is completed normally, the judgment is “yes”, prompting the flow to shift to the step S111. If the command is completed abnormally, the judgment is “no”, prompting the flow to return to the step S101. Note that if the command is completed abnormally, the host computer 19 has been notified of the abnormality at the time of the command process in the step S109 (which is described later in association with FIG. 5).

In the step S111, the command analysis/process unit 13c judges whether or not the command processed in the step S109 is a write series command. If it is a write series command, the judgment is “yes” and the flow shifts the step S112, otherwise the judgment is “no” and the flow shifts the step S115. Note that the “write series command” is a generic term of commands for writing data to the disk medium 18.

The processes of the steps S112 through S114 are ones which are carried out following the execution of a write series command, for protecting data. That is, the processes which the magnetic disk apparatus 11 autonomously verifies the disk medium 18 without an instruction from the host computer 19.

In the step S112, the command analysis/process unit 13c calculates a physical position, on the disk medium 18, of a block to which data is written by the command (i.e., the write series command), which has been processed in the step S109, and notifies the read/write head control unit 15 of the calculation result. Then, the read/write head control unit 15 reads the data from the block and the flow shifts to the step S113.

The step S113 judges whether or not the data which is read out in the step S112 is identical with the data written in the step S109. If they are identical, the judgment is “yes”. In this case, since the write series command has been processed appropriately in the step S109, the process returns to the step S101. If they are not identical, the judgment is “no”, in which case the write series command has not been appropriately processed in the step S109 and therefore the flow shifts to the step S114 for protecting data.

In the step S114, the command analysis/process unit 13c carries out a rewriting process and/or an alternative block allocation process, thereby accomplishing a data protection. That is, it appropriately writes the data which was not written adequately by the process of the step S109 in the step S114, thereby changing to a state enabling a read and use of the data thereafter. The present embodiment is configured so that the command analysis/process unit 13c carries out the following process in the step S114:

The command analysis/process unit 13c first tries a rewrite process. Since the write data of the write series command processed in the step S109 is stored in the cache memory 17, the command analysis/process unit 13c instructs the read/write head control unit 15 to write the data again at the position to which the data has been written in the step S109.

It then reads the written data in the same manner as in the step S112 and judges whether or not the readout data is identical with the written data. If they are identical, meaning that the data has been appropriately written by the rewrite process, and the process of the step S114 accordingly ends and the process returns to the step S101.

If they are not identical, meaning that it is the case of even the rewriting process being unable to write data appropriately. In this event, an alternative block allocation process is carried out. That is, the command analysis/process unit 13c allocates an unused block other than the one to which the data was written in the step S109 as an alternative block corresponding to the aforementioned write series command. It then issues an instruction to the read/write head control unit 15 to write the write data stored in the cache memory 17 to the alternative block. The command analysis/process unit 13c further instructs the read/write head control unit 15 for reading the written data. Then the command analysis/process unit 13c judges whether or not the written data and readout data are identical. If they are identical, meaning that the data is appropriately written by the alternative block allocation process, and therefore the process of the step S114 ends and the flow returns to the step S101.

If they are not identical, a rewriting process may be performed for the alternative block in the same manner as described above, or another alternative block may be allocated. Once it is verified that the data to be written has been appropriately written by those processes, the process of the step S114 ends and the process returns to the step S101.

In the step S115, the command analysis/process unit 13c judges whether or not the command processed in the step S109 is a read series command. If it is a read series command, the judgment is “yes” and process shifts to the step S116, otherwise the judgment is “no” and the process returns to the step S101. Note that the “read series command” is a generic term for commands for reading data from the disk medium 18. Note also that the case of the judgment being “no” is when the command processed in the step S109 is neither a write series command nor read series command and instead is a control series command for instance.

The steps S116 and S117 are processes for a data protection which is performed after executing a read series command.

In the step S116, the command analysis/process unit 13c judges whether or not a recoverable error has occurred when the read series command was processed in the step S109. The step S116 is carried out only when the process of the read series command has been completed normally in the step S109, the process of the step S109, however, also includes a retry process. Accordingly, there is a first case that the read series command is processed without a problem, and there is a second case that an error actually occurred, with the error being recoverable by a retry, and therefore the retry has made it possible to eventually process the read series command normally. The second case corresponds to the case that the read target data was written in the past in a state of the head being at a position displaced from the center of the track, and the case of the disk medium 18 being damaged, making it possible to read data normally only once in several times.

In the first case, the judgment of the step S116 is “no” and the process returns to the step S101.

In the second case, the judgment is “yes” and the flow shifts to the step S117.

In the step S117, the command analysis/process unit 13c carries out a rewrite process and/or alternative block allocation process which are similar to the step S114, thereby accomplishing a data protection.

The execution of the step S117 is for the above described second case and therefore the data has been appropriately read out. Accordingly, the command analysis/process unit 13c carries out a rewrite process and/or alternative block allocation process by using the readout data. That is, it carries out the process of rewriting the data, which has been written to a place displaced from the center position of a track, to the center position of the track, or rewriting the data from the damaged zone of the disk medium 18 to another normal zone. This configuration makes it possible to read the data by higher reliability when executing a read series command thereafter for the data.

Having completed these processes, the process returns to the step S101.

The steps S118 through S128 are carried out when a command does not exist in the command queue 13a and the magnetic disk apparatus 11 is in an idle state. These processes are for maintaining the magnetic disk apparatus 11.

The step S118 judges whether or not it is in a failure prediction state. The judgment method is the same as the step S102. If it is in a failure prediction state, the judgment is “yes” and the flow shifts to the step S119. The steps S119 through S125 correspond to the failure prediction-time operations. If it is not in a failure prediction state, the judgment is “no” and the flow shifts the step S126.

The step S119 judges whether or not the failure prediction condition being established is due to a high temperature. The judgment method is the same as the step S103. If the judgment is that the failure prediction state is due to a high temperature, the judgment results in “yes” and the flow shifts to the step S120, otherwise it results in “no” and the flow shift to the step S123.

The steps S120 through S122 are carried out if the judgment is that the failure prediction state is due to a high temperature. The temperature influences not only the disk medium 18 but also the cache memory 17 and therefore it is desirable to test the cache memory 17 followed by performing an error recovery process if necessary in this case.

The step S120 verifies the cache memory 17. As described above, firmware is comprised in the magnetic disk apparatus 11 for controlling the cache memory 17 for example. In the step S120, the firmware executes a read/write test for the cache memory 17 to inspect a presence or absence of a failure therein.

A concrete test method can be discretionarily selected depending on an embodiment, in which either read test or write test may only be performed. For instance, a Cyclic Redundancy Check (CRC) or an Error Check and Correct (ECC) may be performed. If a zone where an error cannot be corrected is found, a process for inhibiting a use of the zone is carried out in this case. Upon execution of the test, the flow shifts to the step S121.

In the step S121, the above noted firmware which controls the cache memory 17, judges whether or not the test of the step S120 has ended normally. Note that the command analysis/process unit 13c carries out the steps S120 and S121 in another embodiment in which the command analysis/process unit 13c also controls the cache memory 17.

If the test has ended normally, the judgment is “yes” and the flow shifts to the step S123, while if the test did not end normally, the judgment is “no” and the flow shifts to the step S122.

The step S122 performs an error recovery process for the cache memory 17. Specifically, it is a rewrite process or alternative block allocation process which is similar to the step S114 and/or S117. For example, a write test is performed by using specific data in the step S120 and, if the data cannot be written correctly to a certain block, an alternative block allocation process is carried out in the step S122. Upon execution of the error recovery process, the flow shifts to the step S123.

The steps S123 through S125 are for verifying the disk medium 18 at the time of a failure prediction state and for carrying out the error recovery process if necessary.

In the step S123, the command analysis/process unit 13c instructs the read/write head control unit 15, thereby performing a read test of the disk medium 18. Upon completion of the read test, the process shifts to the step S124.

In the step S124, the command analysis/process unit 13c judges whether or not the read test of the step S123 has ended normally. If the test has ended normally, the judgment is “yes” and the flow shifts to the step S126, otherwise the judgment is “no” and the flow shifts to the step S125.

In the step S125, the command analysis/process unit 13c instructs the read/write head control unit 15, thereby carrying out an error recovery process which is specifically a rewrite process and/or alternative block allocation process similar to those of the step S117. This configuration makes the data, which has been written to a position displaced from the center of a track for example, rewritten at the center position of the track so as to suppress an error occurrence when another read series command is executed for the data thereafter. That is, the step S125 is a process for the magnetic disk apparatus 11 trying to return to a normal state autonomously independent of an external instruction during the idle state. Upon execution of the error recovery process, the flow shifts to the step S126.

The steps S126 through S128 are processes relating to system information on the magnetic disk apparatus 11. The system information is one for use in management and control of the magnetic disk apparatus 11 per se. The present embodiment is configured to let a system information management unit (not shown in FIG. 3) which is equipped as firmware manage the system information.

The examples of the system information include a mode selection parameter for setting an operation mode of the magnetic disk apparatus 11, a various pieces of statistical information relating to the operation thereof, et cetera. The system information cannot be accessed from the magnetic disk apparatus 11 by the common read series command or write series command. The system information may be stored in the disk medium 18. Alternatively, the system information may be stored in nonvolatile memory storing the firmware program for the command analysis/process unit 13c, failure prediction time operation logic unit 14, et cetera.

In the step S126, the system information management unit judges whether or not it is a periodical update timing for the system information. If it is an update timing, the judgment is “yes” and the flow shifts to the step S127, while if it is not an update timing, the judgment is “no” and the flow returns to the step S101.

In the step S127, it is judged whether or not it is a failure prediction state. The judgment method is the same as in the step S102. If it is a failure prediction state, the judgment is “yes” and the flow returns to the step S101. If it is not a failure prediction state, the judgment is “no” and the flow shifts to the step S128.

In the step S128, the system information management unit updates the system information. Upon updating the system information, the flow returns to the step S101.

The steps S126 and S128 are processes performed also in the conventional HDD, while a judgment of the step S127 is an operation unique to the present invention. If the judgment of the step S127 is “yes”, the flow returns to the step S101, which is a failure prediction-time operation for inhibiting an execution of the step S128.

In the manner as described above, the process of FIG. 4 is repeatedly carried out during an operation of the magnetic disk apparatus 11.

The next description is of a relationship between FIGS. 2A and 2B and FIG. 4.

If at least one condition of the failure prediction conditions (A) through (D) shown by the table of FIG. 2A is established, it is judged to be a failure prediction state in the steps S102, S106, S118 and S127 of FIG. 4. If the failure prediction condition (A) is established, the reason for the failure prediction condition being established is judged to be due to a high temperature in the steps S103 and S119 of FIG. 4.

The failure prediction-time operations (i.e., paragraphs (1) through (7) in the table of FIG. 2B) and the steps of FIG. 4 are related to each other as follows:

the paragraphs (1) corresponds to the step S108, (2) to the step S104, (3) to the step S108, (4) to the steps S112 through S114, (5) to the step S117, (6) to the steps S126 through S128 and (7) to the steps S119 through S125, respectively.

Incidentally, if the failure prediction condition (C) (i.e., a read error rate is equal to or greater than a specified value) is established, the instruction is to carry out the failure prediction-time operation (4) (i.e., verify the written place) according to FIGS. 2A and 2B. There seems to be a low relativity between the failure prediction condition and failure prediction-time operation at first glance, a read error, however, often occurs because there has already been a problem in writing the data to be currently read. It is desirable to define the relationship between a failure prediction condition and a failure prediction-time operation by analyzing the causes of error occurrences as noted above.

The next description is of the processes carried out in the steps S107 and S109 of FIG. 4 while referring to FIG. 5 which is a flow chart of a command process carried out by the magnetic disk apparatus 11 according to an embodiment.

The magnetic disk apparatus 11 operates in an operation mode specified by a mode selection parameter from among a plurality of operation modes. In a command process for example, a timing for reporting an end of a command to the host computer 19 is different dependent on an operation mode, with one operation mode reporting at the time of ending a reading/writing to the cache memory 17 and another mode reporting at the time of ending a reading/writing to the disk medium 18. FIG. 5 shows the case of the magnetic disk apparatus 11 operating in the latter operation mode. The difference of the operation modes has no direct relationship with the present invention and therefore a description associated with the former operation mode is omitted herein.

In the step S201, the command analysis/process unit 13c judges whether or not a command to be processed is a read series command or write series command. If it is a read series command or write series command, the judgment is “yes” and the flow shifts to the step S202, while if it is another kind of command (e.g., a control series command), the judgment is “no” and the flow shifts to the step S219.

In the step S202, the command analysis/process unit 13c instructs the read/write head control unit 15 to start a seek operation in which the latter controls the arm and moves the head to a target track. Upon starting the seek operation, the flow shifts to the step S203. Note that the steps S203 through S205 are performed in parallel with the seek operation.

In the step S203, the command analysis/process unit 13c judges whether or not the command to be processed is a write series command. If it is a write series command, the judgment is “yes” and the flow shifts to the step S204, while if it is a read series command, the judgment is “no” and the flow shifts to the step S205.

In the step S204, the command analysis/process unit 13c requests the host computer 19, by way of the I/F process unit 12, for transmitting write data of a write series command to be processed. Then the host computer 19 transmits the write data to the magnetic disk apparatus 11. The write data is transmitted, by way of the I/F process unit 12, to the cache memory 17 and stored therein, followed by the flow shifting to the step S206.

In the step S205, the command analysis/process unit 13c grants permission to transfer the read data within the cache memory 17 to the host computer 19. Except that the present embodiment is configured to not transfer the read data at this event. Upon granting the permission, the flow shifts to the step S206.

The step S206 means to wait until a completion of the seek operation. Upon completion of the seek operation, the judgment of the step S206 becomes “yes” and the flow shifts to the step S207, while if the seek operation is still in progress, the judgment is “no” and the step S206 is repeated.

In the step S207, the command analysis/process unit 13c judges whether or not the seek operation has been completed normally based on a report from the read/write head control unit 15. If the seek operation is normally completed, that is, if the head is positioned at a target track, the judgment becomes “yes” and the flow shifts to the step S208, while if the seek operation was not completed normally, the judgment is “no” and the flow shifts to the step S217.

If the command to be processed is a read series command in the step S208, the read/write head control unit 15 starts a read operation (i.e., an operation for reading data from the disk medium 18). Simultaneously with the operation, the data stored in the cache memory 17 is transferred to the host computer 19 by way of the I/F process unit 12 according to the permission granted in the step S205. Meanwhile, if the command to be processed is a write series command, the read/write head control unit 15 starts a write operation (i.e., an operation for writing data stored in the cache memory 17 to the disk medium 18). Either of the read operation or the write operation, it is followed by the flow shifting to the step S209.

The step S209 means to wait until the read operation or write operation started in the step S208 ends. Upon ending the read operation or write operation, the judgment of the S209 becomes “yes” and the flow shifts to the step S210, while if the read or write operation is still in progress, the judgment is “no” and the step S209 is repeated.

In the step S210, the command analysis/process unit 13c judges whether or not the read or write operation has ended normally based on a report from the read/write head control unit 15. If it has ended normally, the judgment is “yes” and the flow shifts to the step S211, otherwise the judgment is “no” and the flow shifts to the step S212.

In the step S211, the command analysis/process unit 13c reports the fact of the command being completed normally to the host computer 19 by way of the I/F process unit 12. The series of the processes ends in the step S211.

The step S212 is one carried out if an error occurs during the read or write operation, resulting in an abnormal end, which is for recording the error information in the error information storage unit 16b.

For example, if an error occurs in the read operation, the command analysis/process unit 13c increments a read error counter within the error information storage unit 16b, while if an error occurs in the write operation, the command analysis/process unit 13c increments a write error counter within the error information storage unit 16b.

The failure prediction condition judgment unit 16c keeps monitoring the error information storage unit 16b, and keeps calculating a read error rate or write error rate according to the kind of a processed command. And it detects an establishment, or not, of a failure prediction condition (corresponding to the failure prediction conditions (C) and (D) shown in FIG. 2A) based on whether or not the error rate has exceeded a predefined threshold value. When detecting an establishment of a failure prediction condition, the failure prediction condition judgment unit 16c notifies the failure prediction time operation logic unit 14 of detecting the establishment. This enables a taking of countermeasures such as the failure prediction-time operations (1) through (7) shown in FIG. 2B at the time of processing subsequent commands. After a notification to the failure prediction time operation logic unit 14, the flow shifts to the step S213.

In the step S213, the command analysis/process unit 13c judges whether or not a retry of the read operation or write operation is possible. The present embodiment is configured to predetermine the maximum number of times that the retry is permitted per one command, and accordingly the judgment is to permit retries until reaching the aforementioned number. Another embodiment may judge it by another criterion. If a retry is possible, the judgment is “yes” and the flow shifts to the step S214, while if a retry is not possible, the judgment is “no” and the flow shifts to the step S215.

In the step S214, the command analysis/process unit 13c records the fact of executing a retry of the read operation or write operation.

The present embodiment is configured to implement the command analysis/process unit 13c and read/write head control unit 15 as firmware and the execution of the retry is recorded in RAM accessible from these functional blocks. This RAM may be a part of the error information storage unit 16b.

The command analysis/process unit 13c judges whether or not a recoverable error has occurred during the processing of a read series command in the step S116 shown in FIG. 4 based on the aforementioned record and the fact of whether or not the read operation has eventually been completed normally. The record of the fact of executing a retry is also used at the time of judging based on the number of retries in the step S213.

Furthermore in the step S214, the read/write head control unit 15 starts a retry process based on an instruction of the command analysis/process unit 13c. After the start of the retry process, the flow returns to the step S209, followed by carrying out the same process as described above.

The step S215 is one carried out if the read operation or write operation did not end normally and if a retry is not possible. In the step S215, the command analysis/process unit 13c records the fact of an occurrence of an irrecoverable error during the read operation or write operation in the RAM (i.e., the RAM utilized in the step S214). This record enables a judgment of an occurrence of an irrecoverable error in the step S116 shown in FIG. 4. Following the recording, the flow shifts to the step S216.

The step S216 is carried out if a read operation or write operation has not ended normally and if a retry is not possible. In the step S216, the command analysis/process unit 13c reports the fact of a command ending abnormally to the host computer 19 by way of the I/F process unit 12, and the series of processes ends.

In the step S217, the command analysis/process unit 13c judges whether or not a retry process for the seek operation is possible. If a retry is possible, the judgment is “yes” and the flow shifts to the step S218. If a retry is not possible, the judgment is “no”, in which case the fact of an abnormal end without the command being processed is the same as the case of the judgment being “no” in the step S213 and therefore the flow shifts to the step S216.

A person skilled in the art is capable of determining appropriately whether or not a retry process is possible depending on the embodiment. For instance, a configuration may be such that the maximum number of times of permissible retries is predetermined so as to judge that a retry is possible until the aforementioned number is reached.

In the step S218, the command analysis/process unit 13c records the fact of carrying out a retry of the seek operation in the RAM utilized in the step S214. Then, the read/write head control unit 15 starts a retry process of the seek operation based on an instruction of the command analysis/process unit 13c, and the flow returns to the step S206.

The steps S219 and S220 are ones for processing a command which is neither read series command nor write series command. For instance, a control series command such as a command for specifying a mode selection parameter is processed in the steps S219 and S220.

In the step S219, the command analysis/process unit 13c instructs the read/write head control unit 15 if necessary to process the aforementioned command and the flow shifts to the step S220.

In the step S220, the command analysis/process unit 13c reports the fact of completing the command process to the host computer 19 by way of the I/F process unit 12. The step S220 completes the series of processes.

Note that the present invention can be modified in various manners in lieu of being limited by the above described embodiments. The following exemplifies some of them:

While the interface of the magnetic disk apparatus 11 shown in FIG. 3 is SCSI, other discretionary interfaces including AT Attachment (ATA), et cetera, may be applicable.

The above description refers to a configuration in which an error occurrence during a command execution is reported to the command analysis/process unit 13c by the read/write head control unit 15, and the error information is recorded in the error information storage unit 16b. In another embodiment, however, the error information storage unit 16b may further include firmware for monitoring an error occurrence. And the configuration may be such that the firmware obtains error information by monitoring reports from the read/write head control unit 15 to the command analysis/process unit 13c and writes the error information to RAM constituting the error information storage unit 16b.

In an embodiment equipped with each block shown in FIG. 3 by firmware, the functions of a plurality of blocks may be implemented by one firmware program. For instance, the command analysis/process unit 13c and failure prediction time operation logic unit 14 may be implemented by separate firmware programs or a single firmware program.

In the step S104 of FIG. 4, the wait time may be a discretionary time, in lieu of being limited by 50 ms. Or the wait time may be constant, or may be variable in accordance with temperature detected by the temperature sensor 16a. Furthermore, an execution sequence of commands within the command queue 13a may be arranged in a manner to further increase the wait time in the step S104. Alternatively, such an arrangement only may be carried out in lieu of inserting the wait time in the step S104. Either of these methods provides a benefit of suppressing a temperature rise because the execution interval of commands is extended by increasing the wait time.

The process of the step S114 shown in FIG. 4 varies with embodiment. An alternative block allocation process is carried out in the case of data not being appropriately written by one rewrite process in the above description, another embodiment, however, may try the rewrite processes up to a predetermined number of times. Yet another embodiment may first carry out an alternative block allocation process in place of performing a rewrite process.

In FIG. 4, if a command does not exist in the command queue 13a and the magnetic disk apparatus 11 is in an idle state, the processes of the steps S118 through S128 are carried out. Another embodiment, however, may carry out the processes of the steps S118 through S128 only in the case of the idle state continuing for a specified period of time or longer.

The combinations between the failure prediction conditions and failure prediction-time operations shown in FIGS. 2A and 2B are merely examples. Other combinations are also possible. Other failure prediction-time operations in addition to those shown in FIGS. 2A and 2B for a certain failure prediction condition may be combined for execution, or some among the failure prediction-time operations shown in FIGS. 2A and 2B may be chosen to be not executed.

For instance, in the case of the host computer 19 instructing the magnetic disk apparatus 11 for executing a write series command, the write series command is executed in the step S109 even in a failure prediction state according to the flow shown in FIG. 4. Another embodiment, however, may choose to not execute a write series command in a failure prediction state, and instead report the error to the host computer 19, thereby protecting the current data.

Meanwhile, various conditions in addition to those shown in FIGS. 2A and 2B may be used as failure prediction conditions. For example, the following conditions may be used:

Total power-on time of the magnetic disk apparatus 11 is equal to or greater than a specified length of time;

the number of times of starting (i.e., the number of power on/off) the spindle motor is equal to or greater than a specified value;

driving time of the spindle motor is equal to or greater than a specified value;

detecting a decrease of a head output;

a seek error rate is equal to or greater than a specified value;

the number of retry times of seek operations is equal to or greater than a specified value;

the number of retry times of read operations is equal to or greater than a specified value;

the number of retry times of write operations is equal to or greater than a specified value;

the number of continuous error occurrences is equal to or greater than a specified value; or

the cumulative number of sectors, to which a read operation or write operation has been carried out, is equal to or greater than a specified value.

Still additionally, it is possible to define various failure prediction conditions by various inspection items, and threshold values corresponding to those items, which are utilized for a magnetic disk apparatus equipped with a SMART function. Depending on the kind of a failure prediction condition, a sensor other than the temperature sensor 16a may sometimes be required. And a specific configuration of the error information storage unit 16b may vary with definition of a failure prediction condition.

The process steps may increase with failure prediction condition to be utilized. For instance, in an embodiment utilizing a failure prediction condition based on a seek error, the command analysis/process unit 13c records an occurrence of a seek error in the error information storage unit 16b in the same manner as the step S212, in a step added between the steps S207 and S217 shown in FIG. 5. Meanwhile, in an embodiment utilizing a failure prediction condition based on the number of retry times of seek operations, the command analysis/process unit 13c records the fact of a retry being impossible in the RAM in the same manner as the step S215, in a step added between the steps S217 and S216 shown in FIG. 5.

Note that although FIGS. 2A and 2B, and the above described failure prediction conditions use “equal to or greater than” or “equal to or less than” for the respective definitions, “greater than . . . ” or “smaller than . . . ” may be used depending on an embodiment. And, FIGS. 2A and 2B, and the above described failure prediction conditions use simple conditions such as “operation at or higher than a specified temperature”, the failure prediction conditions, however, may be defined by combining a plurality of conditions such as “operation at, or higher than, a specified temperature has continued for a specified length of time or longer, and also a read error rate is at, or higher than, a specified value”, for example.

The description thus far has stated on the case of shifting from a normal state to a state of establishing a failure prediction condition, while omitting the reverse case. There is a case, however, of returning to a normal state as a result of carrying out the processes shown in FIG. 4, and FIGS. 2A and 2B.

Returning to a normal state is detected by the failure prediction condition judgment unit 16c based on information of the temperature sensor 16a or error information storage unit 16b. That is, the failure prediction condition judgment unit 16c detects the fact that a previously established failure prediction condition is no longer established. And the failure prediction condition judgment unit 16c notifies the failure prediction time operation logic unit 14 of the return to a normal state. That is, the operation principle is the same as the case of changing to a failure prediction state from a normal state.

The present invention can also be applied to storage apparatuses in addition to the magnetic disk apparatus, e.g., an optical disk apparatus such as a DVD, a magneto optical disk apparatus such as an MO.

What is claimed is:

1. A storage apparatus receiving either category of a command among a plurality of categories including a reading of data from a storage medium or a writing of data thereto and carrying out the command, comprising:
a failure prediction condition detection unit for detecting whether or not a predefined failure prediction condition, as a condition for a failure occurrence being predicted, is established; and
a failure prediction time operation logic unit for instructing an execution of an operation which is predetermined corresponding to the failure prediction condition when the failure prediction condition detection unit detects an establishment of the failure prediction condition.

2. The storage apparatus according to claim 1, wherein
said failure prediction condition detection unit includes a temperature detection unit for detecting temperature, and
said failure prediction condition includes a condition which temperature of a predetermined temperature or higher is detected by the temperature detection unit.

3. The storage apparatus according to claim 2, wherein
said operation corresponding to said failure prediction condition is an operation for reducing a current volume at the time of a seek.

4. The storage apparatus according to claim 2, further comprising
a command queue for queuing a plurality of commands, wherein
said operation corresponding to said failure prediction condition is an operation for inhibiting a rearrangement of commands within said command queue so as to decrease a wait time.

5. The storage apparatus according to claim 2, further comprising
a command queue for queuing a plurality of commands, wherein
said operation corresponding to said failure prediction condition is an operation for rearranging commands within said command queue so as to increase a wait time.

6. The storage apparatus according to claim 2, wherein
said operation corresponding to said failure prediction condition is an operation for inserting a wait time between two consecutive commands.

7. The storage apparatus according to claim 1, wherein
one of said operations predetermined corresponding to said failure prediction condition is an operation for making a positioning condition to a target track more strict in a seek operation.

8. The storage apparatus according to claim 1, wherein
one of said operations predetermined corresponding to said failure prediction condition is determined as an operation to be carried out in the case of said command being one for instructing a data writing to said storage medium, and
the operation includes a judgment operation which comprises reading, after the command being carried out, of data from a block of the storage medium to which the data is written and judging whether or not said written data and said read data are identical.

9. The storage apparatus according to claim 8, wherein
said operation further includes an operation for writing said data instructed by said command again to said block when said judgment operation judges “not identical”.

10. The storage apparatus according to claim 8, wherein
said operation further includes an operation for writing said data instructed by said command to another block which is different from said block when said judgment operation judges “not identical”.

11. The storage apparatus according to claim 1, wherein
said command is one for instructing a reading of data from said storage medium, one of said operations predetermined corresponding to said failure prediction condition is determined as an operation to be carried out in the case in which an error recoverable by a retry process occurs during the command being carried out, and
the operation includes an operation for writing the data read out by the command to the storage medium after carrying out the command.

12. The storage apparatus according to claim 11, wherein
said operation is one for writing said data to a block of said storage medium from which the data is read.

13. The storage apparatus according to claim 11, wherein
said operation is one for writing said data to another block of said storage medium which is different from the block from which the data is read.

14. The storage apparatus according to claim 1, wherein
system information for managing the storage apparatus is recorded by said storage medium, and
one of said operations predetermined corresponding to said failure prediction condition is an operation for inhibiting an update of the system information.

15. The storage apparatus according to claim 1, wherein
one of said operations predetermined corresponding to said failure prediction condition is determined as an operation to be carried out in the case that a state of not carrying out a command continues for a predefined period of time or more.

16. The storage apparatus according to claim 15, further comprising
a cache memory, wherein
said operation is one for inspecting a failure of the cache memory.

17. The storage apparatus according to claim 15, wherein
said operation is one for reading data from said storage medium and inspecting a failure thereof.

18. The storage apparatus according to claim 1, wherein
said failure prediction condition detection unit measures at least one among temperature, the number of error occurrences, a ratio of error occurrences, an operation time of the storage apparatus and the number of operations for supplying the storage apparatus with power, and
said failure prediction condition is defined by using a result of comparing between a value obtained by the measurement and a predetermined threshold value.

19. A method for controlling a storage apparatus receiving either category of a command among a plurality of categories including a reading of data from a storage medium or a writing of data thereto and carrying out the command, comprising:
detecting whether or not a predefined failure prediction condition, as a condition for a failure occurrence being predicted, is established; and
instructing an execution of an operation which is predetermined corresponding to the failure prediction condition that is detected to be established.

20. A control apparatus receiving either category of a command among a plurality of categories including a reading of data from a storage medium or a writing of data thereto and carrying out the command, comprising:
a failure prediction condition detection unit for detecting whether or not a predefined failure prediction condition, as a condition for a failure occurrence being predicted, is established; and
a failure prediction time operation logic unit for instructing an execution of an operation which is predetermined corresponding to the failure prediction condition when the failure prediction condition detection unit detects an establishment of the failure prediction condition.
